(19) United States
(12) Patent Application Publication
(10) Pub. No.: US 2018/0173560 A1
(43) Pub. Date: Jun. 21, 2018

(54) PROCESSING CIRCUIT HARDWARE RESOURCE ALLOCATION SYSTEM

(71) Applicant: Apple Inc., Cupertino, CA (US)

(72) Inventors: Gokhan Avkarogullari, San Jose, CA (US); Terence M. Potter, Austin, TX (US); Benjiman L. Goodman, Cedar Park, TX (US); Ralph C. Taylor, Orlando, FL (US); Kutty Banerjee, San Jose, CA (US)

(21) Appl. No.: 15/386,570

(22) Filed: Dec. 21, 2016

(51) Int. Cl. G06F 9/48; G06F 9/50

(52) U.S. Cl. CPC G06F 9/4818; G06F 9/505

(57) ABSTRACT

In various embodiments, hardware resources of a processing circuit may be allocated to a plurality of processes based on priorities of the processes. A hardware resource utilization sensor may detect a current utilization of the hardware resources by a process. A utilization accumulation circuit may determine a utilization of the hardware resources by the process over a particular amount of time. A target utilization of the hardware resources for the process may be determined based on the utilization of the hardware resources over the particular amount of time. A comparator circuit may compare the current utilization to the target utilization. A process priority adjustment circuit may adjust a priority of the process based on the comparison. Based on the adjusted priority, a different amount of hardware resources may be allocated to the processes.

### BACKGROUND

### Technical Field

This disclosure relates generally to a processing circuit hardware resource allocation system.

### Description of the Related Art

One goal for managing hardware resources of computing devices (e.g., graphics processing units (GPUs)) is utilizing as much of the computing device as much of the time as possible. One way a utilization of hardware resources may be increased is by simultaneously executing multiple processes in parallel and dynamically allocating the hardware resources between the processes. However, in many cases, hardware resources may not be able to be allocated at a fine enough granularity to match a requested division of hardware resources, potentially resulting in starvation of one or more processes (e.g., one or more lower priority processes). Additionally, in many cases, software systems that generate the requested division of hardware resources may be unable to detect that the hardware resources have been allocated differently.

### SUMMARY

In various embodiments, a processing circuit hardware resource allocation system is disclosed where one or more quality of service mechanisms are used to allocate hardware resources to a plurality of processes of a processing system (e.g., a GPU). The hardware resources may be allocated to the plurality of processes based on priorities of the processes. A hardware resource utilization sensor may detect a current utilization of the hardware resources by a process. A utilization accumulation circuit may determine a utilization of the hardware resources by the process over a particular amount of time. A target utilization of the hardware resources for the process may be determined based on the utilization of the hardware resources over the particular amount of time. A comparator circuit may compare the current utilization to the target utilization. A process priority adjustment circuit may adjust a priority of the process based on the comparison. Based on the adjusted priority, a different amount of hardware resources may be allocated to the processes. As a result, the allocation of hardware resources to the processes may be more accurately controlled over a window of time (e.g., 10 microseconds or 100 milliseconds) at multiple computing devices, as compared to a system where resources are allocated once based on priorities. Additionally, the system may detect that hardware resources are not being utilized as expected based on the priorities. In some cases, detecting that the hardware resources are not being utilized as expected may result in the system identifying one or more ill-behaved or hung processes. Further, in some cases, the allocation of hardware resources may be controlled at a finer temporal granularity, as compared to a system where a software program controls allocation of the hardware resources.

### BRIEF DESCRIPTION OF THE DRAWINGS

FIG. 1 is a block diagram illustrating one embodiment of a graphics processing unit that includes a processing circuit hardware resource allocation system.

FIG. 2 is a block diagram illustrating one embodiment of devices that include a processing circuit hardware resource allocation system.

FIG. 3 is a block diagram illustrating one embodiment of a processing circuit hardware resource allocation system.

FIG. 4 is a flow diagram illustrating one embodiment of a method of allocating hardware resources of a processing circuit.

FIG. 5 is block diagram illustrating an embodiment of a computing system that includes at least a portion of a processing circuit hardware resource allocation system.

FIG. 6 is a block diagram illustrating one embodiment of a process of fabricating at least a portion of a processing circuit hardware resource allocation system.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation [entity] configured to [perform one or more tasks] is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. s phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a processing circuit that includes six clusters, the terms “first cluster” and “second cluster” can be used to refer to any two of the six clusters, and not, for example, just logical clusters 0 and 1.

When used in the claims, the term “or” is used as an inclusive or and not as an exclusive or. For example, the phrase “at least one of x, y, or z” means any one of x, y, and z, as well as any combination thereof (e.g., x and y, but not z).

In the following description, numerous specific details are set forth to provide a thorough understanding of the disclosed embodiments. One having ordinary skill in the art, however, should recognize that aspects of disclosed embodiments might be practiced without these specific details. In some instances, well-known circuits, structures, signals, computer program instruction, and techniques have not been shown in detail to avoid obscuring the disclosed embodiments.

### DETAILED DESCRIPTION

A processing circuit hardware resource allocation system is disclosed herein where hardware resources of a plurality of clusters (e.g., united shader clusters) of a processing system (e.g., a GPU) may be distributed between a plurality of processes. In various embodiments, data for the plurality of processes may be received at some or all of the clusters from one or more process queues. At least one of the clusters may include one or more hardware resource utilization sensors, a hardware resource arbitration circuit, and a process priority list. The process priority list may store priorities for at least some of the plurality of processes. Based on the priorities, the hardware resource arbitration circuit may allocate the hardware resources to the plurality of processes. The one or more hardware resource utilization sensors may detect a current utilization of the hardware resources of a respective cluster by a respective process.

In various embodiments, the processing circuit hardware resource allocation system may further include one or more director circuits. The one or more director circuits may receive the current utilization of the hardware resources for a process and, in some cases, may adjust a priority of the process. For example, a director circuit may receive the current utilization of hardware resources at the plurality of clusters by a process. The director circuit may include a utilization accumulation circuit that may determine, based on one or more current utilizations from one or more clusters, a utilization of the hardware resources by the process over a particular amount of time. A target utilization of the hardware resources for the process may be determined based on the utilization of the hardware resources over the particular amount of time. A comparator circuit may compare the current utilization to the target utilization. A process priority adjustment circuit may adjust a priority of the process at one or more of the clusters based on the comparison by sending a priority signal to the priority list of the one or more clusters. Based on the adjusted priority, a different amount of hardware resources may be allocated to the processes.

As a result, in some cases, the allocation of hardware resources to the processes may be more accurately controlled over a window of time (e.g., 10 μs or 100 ms) at multiple clusters, as compared to a system where resources are allocated once based on priorities or a system where resources are allocated using a pure software approach. Additionally, the system may detect that hardware resources are not being utilized as expected based on the priorities of the processes. In some cases, detecting that the hardware resources are not being utilized as expected may result in the system identifying one or more ill-behaved or hung processes.

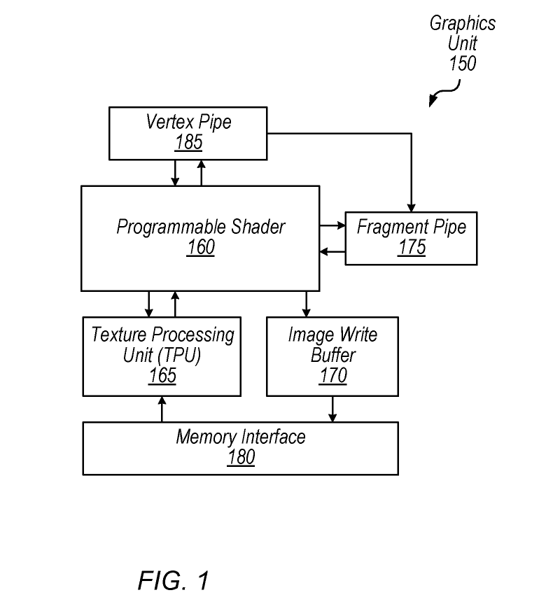

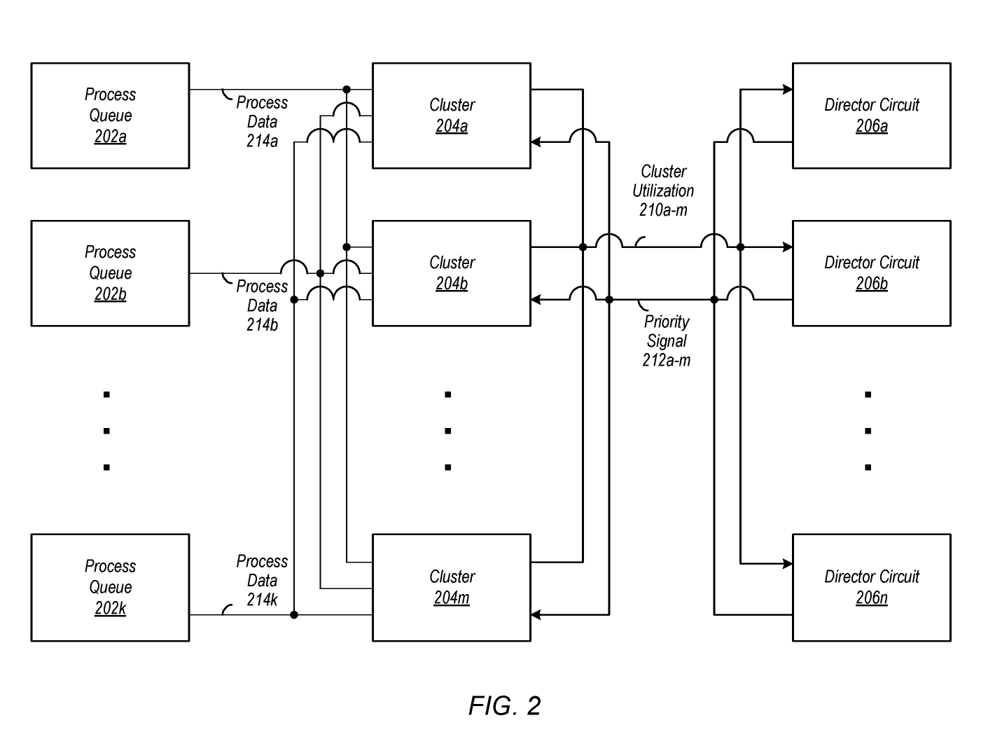

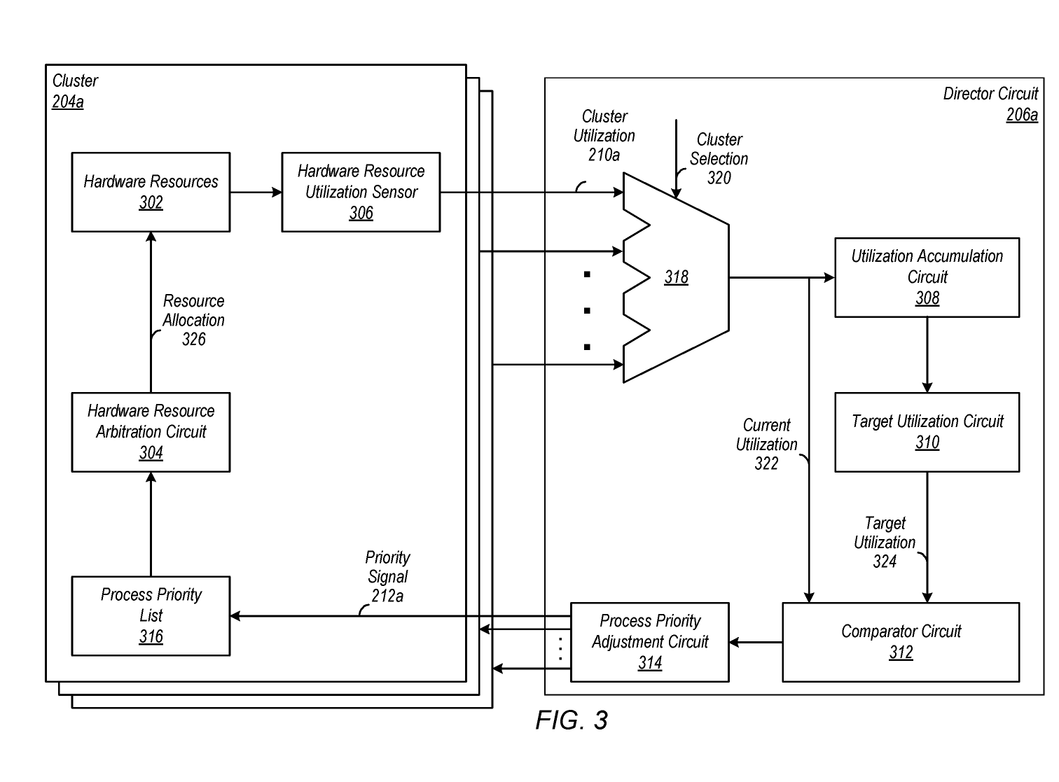

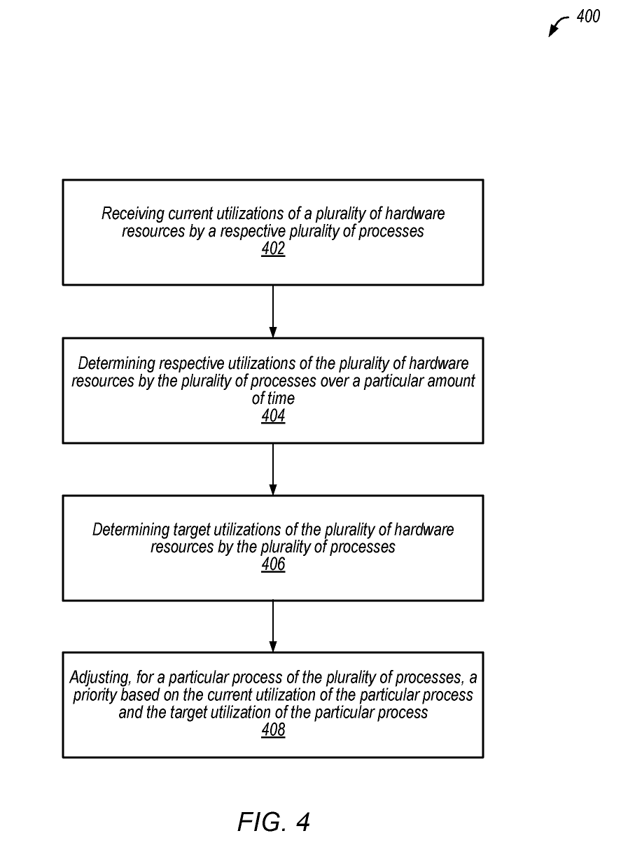

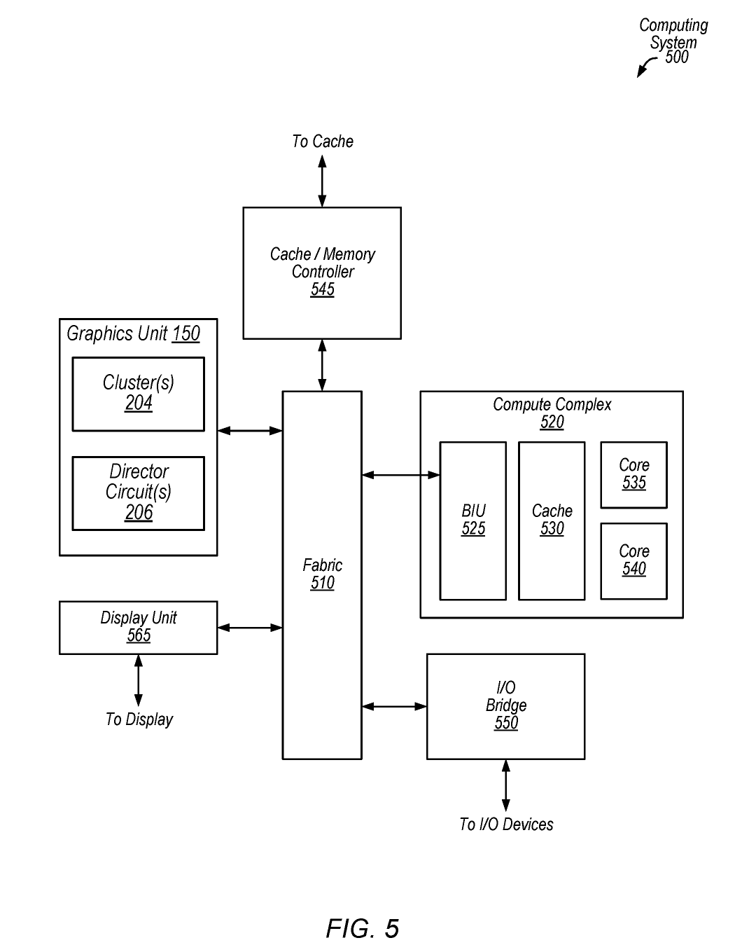

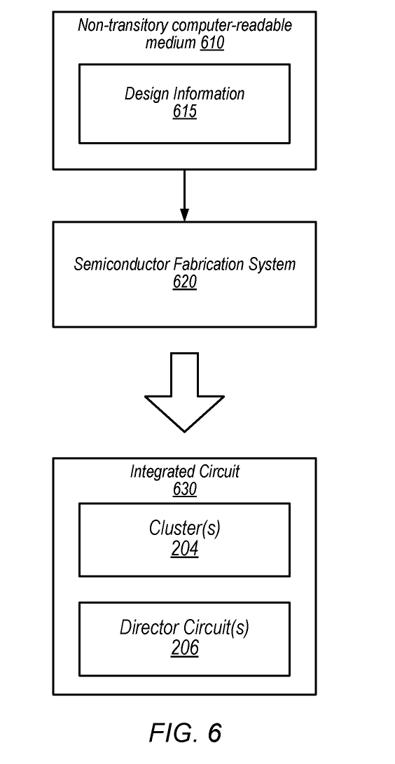

This disclosure initially describes, with reference to FIG. 1, various embodiments of a graphics processing unit (GPU) that includes a processing circuit hardware resource allocation system. Various embodiments of devices that include a processing circuit hardware resource allocation system are described with reference to FIG. 2. An example processing circuit hardware resource allocation system is described with reference to FIG. 3. A method of allocating hardware resources is described with reference to FIG. 4. An embodiment of a computing system that includes a processing circuit hardware resource allocation system is described with reference to FIG. 5. Finally, a process of fabricating one embodiment of a processing circuit hardware resource allocation system is described with reference to FIG. 6.

Turning now to FIG. 1, a simplified block diagram illustrating one embodiment of a graphics unit 150 is shown. In the illustrated embodiment, graphics unit 150 includes programmable shader 160, vertex pipe 185, fragment pipe 175, texture processing unit (TPU) 165, image write buffer 170, and memory interface 180. In some embodiments, graphics unit 150 is configured to process both vertex and fragment data using programmable shader 160, which may be configured to process data (e.g., graphics data) in parallel using multiple execution pipelines or instances. In some embodiments, the multiple execution pipelines correspond to a plurality of execution units of a processing circuit hardware resource allocation system.

Vertex pipe 185, in the illustrated embodiment, may include various fixed-function hardware configured to process vertex data. Vertex pipe 185 may be configured to communicate with programmable shader 160 to coordinate vertex processing. In the illustrated embodiment, vertex pipe 185 is configured to send processed data to fragment pipe 175 and/or programmable shader 160 for further processing.

Fragment pipe 175, in the illustrated embodiment, may include various fixed-function hardware configured to process pixel data. Fragment pipe 175 may be configured to communicate with programmable shader 160 in order to coordinate fragment processing. Fragment pipe 175 may be configured to perform rasterization on polygons from vertex pipe 185 and/or programmable shader 160 to generate fragment data. Vertex pipe 185 and/or fragment pipe 175 may be coupled to memory interface 180 (coupling not shown) in order to access graphics data.

Programmable shader 160, in the illustrated embodiment, is configured to receive vertex data from vertex pipe 185 and fragment data from fragment pipe 175 and/or TPU 165. Programmable shader 160 may be configured to perform vertex processing tasks on vertex data which may include various transformations and/or adjustments of vertex data. Programmable shader 160, in the illustrated embodiment, is also configured to perform fragment processing tasks on pixel data such as texturing and shading, for example. Programmable shader 160 may include multiple execution instances for processing data in parallel. In various embodiments, portions (e.g., execution units, registers, arithmetic logic units, memory locations, etc.) of programmable shader 160 may be usable by multiple processes (e.g., vertex processing tasks, compute processing tasks and fragment processing tasks). The portions of programmable shader 160 may be allocated to various processes during execution of those processes.

TPU 165, in the illustrated embodiment, is configured to schedule fragment processing tasks from programmable shader 160. In some embodiments, TPU 165 is configured to pre-fetch texture data and assign initial colors to fragments for further processing by programmable shader 160 (e.g., via memory interface 180). TPU 165 may be configured to provide fragment components in normalized integer formats or floating-point formats, for example. In some embodiments, TPU 165 is configured to provide fragments in groups of four (a “fragment quad”) in a 2×2 format to be processed by a group of four execution pipelines in programmable shader 160.

Image write buffer 170, in the illustrated embodiment, is configured to store processed tiles of an image and may perform final operations to a rendered image before it is transferred to a frame buffer (e.g., in a system memory via memory interface 180). Memory interface 180 may facilitate communications with one or more of various memory hierarchies in various embodiments.

In various embodiments, a programmable shader such as programmable shader 160 may be coupled in any of various appropriate configurations to other programmable and/or fixed-function elements in a graphics unit. The embodiment of FIG. 1 shows one possible configuration of a graphics unit 150 for illustrative purposes.

Turning now to FIG. 2, a block diagram of devices that include an embodiment of a processing circuit hardware resource allocation system is shown. In the illustrated embodiment, process queues 202a-k, clusters 204a-m, and director circuits 206a-n are shown. Although process queues 202a-k, clusters 204a-m, and director circuits 206a-n are interconnected in a particular manner in the illustrated embodiment, in other embodiments, process queues 202a-k, clusters 204a-m, and director circuits 206a-n may be connected in other manners (e.g., process queue 202k may not be connected to cluster 204a). In various embodiments, different amounts of at least one of process queues 202a-k, clusters 204a-m, or director circuits 206a-n may be present. In various embodiments, some or all of the devices of FIG. 2 may be part of one or more devices of graphics unit 150 of FIG. 1.

Process queues 202a-k may store data for a plurality of respective processes and may provide the data to clusters 204a-m as process data 214a-k. Process data of a single process queue may be provided to a single cluster or to multiple clusters. The process data provided to multiple clusters may be the same or different. Additionally, multiple process queues may provide process data to a single cluster. For example, process queue 202a may provide a first portion of process data 214a to cluster 204a and a second portion of process data 214a to cluster 204m. During a same execution cycle, process queue 202b may provide a first portion of process data 214b to cluster 204m and a second portion of process data 214b to cluster 204b. Process queues 202a-k may correspond to different functional aspects of the system. For example, in some embodiments, process queues 202a-k may correspond to various data master (e.g., vertex data master, pixel data master, compute data master, etc.) functions of a GPU. Processes may be allocated to process queues 202a-k based on the functions performed by the processes. In the illustrated embodiment, process data 214a includes data for only a single process. In some cases, the data may correspond to multiple threads of the single process. In other embodiments, process data 214a may include data for multiple processes. In some embodiments, process queues 202a-k may be software queues. In other embodiments, process queues 202a-k may be hardware queues.

Clusters 204a-m may include hardware resources used to perform various computing actions using process data. As noted above, in some cases, clusters 204a-m may receive process data from multiple processes. For example, cluster 204m may receive a portion of process data 214a and a portion of process data 214b. When process data corresponding to multiple processes is received, clusters 204a-m may allocate respective hardware resources to the processes based on priorities of the processes. In various embodiments, the priorities may be determined based on at least one of a process type, a priority requested by the process queue, or a queue from which the process is received. For example, processes relating to a user interface may have a specified range of priorities (e.g., at least one of a specified minimum priority, a specified maximum priority, or a specified initial priority). As another example, processes received from a vertex queue may have a specified range of priorities. In some cases, the hardware resources of clusters 204a-m may not be utilized as indicated by the priorities. Clusters 204a-m may periodically indicate the utilization of the hardware resources by the various processes to director circuits 206a-n via cluster utilizations 210a-m. Cluster utilizations 210a-m may represent a utilization of hardware resources for a particular amount of time or may represent an instantaneous utilization of hardware resources. In response to cluster utilizations 210a-m, clusters 204a-m may receive priority signals 212a-m, which may modify one or more priorities at clusters 204a-m. Clusters 204a-m may reallocate the hardware resources based on the modified priorities. In some embodiments, the hardware resources may be reallocated to be within a specified range over a specified amount of time.

As an example, in some embodiments, cluster 204a may include twenty registers and may further include requests from a first process and a second process. The priorities of the processes may indicate that the first process should receive eighty percent of the registers (sixteen registers) and the second process should receive twenty percent of the registers (four registers). However, the first process may be unable to proceed with fewer than ten registers and the second process may be unable to proceed with fewer than six registers. Accordingly, because, in the example, the allocated four registers is insufficient, cluster utilization 210a-m may indicate that the second process is not utilizing the allocated registers. Priority signals 212a-m may adjust the priorities so the second process is not allocated any of the registers half of the time and receives forty percent of the registers (eight registers) the other half of the time. As a result, this adjustment may allow the specified resource allocation ratios to be maintained while allowing both processes to make progress.

Director circuits 206a-n may receive cluster utilizations 210a-m and may determine whether to adjust the priorities at clusters 204a-m. In particular, as described further below, director circuits 206a-n may determine, for a particular process, a target utilization from one or more iterations of at least one of cluster utilizations 210a-m. Based on a comparison between the target utilization and a current utilization, one or more of director circuits 206a-n may adjust a priority of a process at one or more of clusters 204a-m. As a result, processes may receive an allocated amount of hardware resources over a window of time. Additionally, director circuits 206a-n may detect that one or more processes are ill-behaved (e.g., requesting resources and failing to utilize them) or hung (e.g., failing to continue execution). In some cases, director circuits 206a-n may indicate, via priority signals 212a-m or via another signal, that a context switch should occur with regard to a process, removing the process from clusters 204a-m. In some embodiments, each director circuit 206a-n corresponds to a different process. Accordingly, in some embodiments where each of process queues 202a-k sends process data for a single process to clusters 204a-m at a time, director circuit(s) 206 may correspond to different process queue(s) 202.

Turning now to FIG. 3, a block diagram illustrating an embodiment of a processing circuit hardware resource allocation system is shown. As discussed above, cluster 204a and director circuit 206a may be part of a larger processing system. However, for clarity's sake, various portions of the system of FIG. 2 are not shown. In the illustrated embodiment, cluster 204a includes hardware resources 302, hardware resource arbitration circuit 304, hardware resource utilization sensor 306, and process priority list 316. In the illustrated embodiment, director circuit 206a includes utilization accumulation circuit 308, target utilization circuit 310, comparator circuit 312, process priority adjustment circuit 314, and switching circuit 318. In various embodiments, the system may include multiple instances of various circuits. For example, in some embodiments, cluster 204a may include multiple instances of hardware resource utilization sensor 306, corresponding to various director circuits. As another example, rather than process priority adjustment circuit 314 communicating with multiple clusters, director circuit 206a may include multiple instances of process priority adjustment circuit 314. In some embodiments, clusters 204a-m, director circuits 206a-n, or both may not include various respective illustrated portions of cluster 204a and/or director circuit 206a. For example, target utilization circuit 310 may correspond to both director circuit 206a and director circuit 206b.

As described above, cluster 204a may receive process data from multiple processes. The processes may execute by utilizing hardware resources 302 (e.g., registers, execution units, logic units, cache entries, program state storage circuitry such as circuitry used to hold a program counter, etc.). The processes may request more hardware resources than are available. Accordingly, hardware resource arbitration circuit may, via resource allocation 326, allocate hardware resources 302 between the processes based on priorities received from process priority list 316. Hardware resource utilization sensor 306 may monitor utilization of the allocated resources of hardware resources 302 by one or more of the processes and may generate cluster utilization 210a. Cluster utilization 210a may indicate a portion of hardware resources 302 allocated to the process and whether the resources were utilized. In some cases, some portions of hardware resources 302 (e.g., registers) may be weighted differently from other portions of hardware resources 302 (e.g., execution units). In the illustrated embodiment, hardware resource utilization sensor 306 may periodically send cluster utilization 210a to director circuit 206a. Cluster utilization 210a may represent a utilization of hardware resources 302 over a specified amount of time (e.g., 1 millisecond, 1 second, or a lifetime of a corresponding process) or may represent a utilization of hardware resources 302 at a specific time.

As described above, director circuit 206a may receive cluster utilization indications from a plurality of clusters. The cluster indications may indicate utilization of hardware resources by one or more processes at the respective clusters. In the illustrated embodiment, director circuit 206a may receive cluster utilization 210a at switching circuit 318. Switching circuit 318 may output cluster utilizations as current utilization 322 based on cluster selection 320. In some embodiments, switching circuit 318 may include one or more multiplexers. Current utilization 322 may be sent to utilization accumulation circuit 308 and to comparator circuit 312. Utilization accumulation circuit 308 may determine the utilization of hardware resources (e.g., at clusters 204a-m) by the process over a particular amount of time (e.g., 10 μs or 100 ms). In the illustrated embodiment, utilization accumulation circuit 308 may output an indication of the utilization of the hardware resources to target utilization circuit 310. Target utilization circuit 310 may use the utilization of the hardware resources to identify a target utilization 324 of hardware resources for a particular cluster. For example, in the illustrated embodiment, target utilization circuit 310 indicates a target utilization of hardware resources 302 for a process monitored by hardware resource utilization sensor 306 when current utilization 322 corresponds to cluster utilization 210a. Target utilization 324 may indicate a number of resources to be given to the process during a next specified period of time (e.g., until target utilization 324 is recalculated for hardware resources 302). In some embodiments, target utilization circuit 310 may determine target utilization 324 based on a utilization of hardware resources by one or more other processes (e.g., received at cluster 204a from other process queues than the process corresponding to director circuit 206a). In some embodiments, target utilization circuit 310 may determine target utilization 324 by tracking a number of threads of the process that are consumed. In some embodiments, one or more software components (e.g., run at director circuit 206a or at one or more processors external to director circuit 206a) may be used to determine target utilization 324.

Comparator circuit 312 may compare current utilization 322 to target utilization 324 and may output a result to process priority adjustment circuit 314. Additionally, in some embodiments, comparator circuit 312 may convert current utilization 322 into a format of target utilization 324 (e.g., a percentage). The result may indicate a difference between current utilization 322 and target utilization 324. The result may indicate that a difference between current utilization 322 and target utilization 324 is within a specified range (e.g., current utilization 322 is at least 10% larger than target utilization 324, current utilization 322 and target utilization 324 are less than 10% of each other, or current utilization is at least 10% smaller than target utilization 324). In some embodiments, several ranges may be used (e.g., current utilization 322 is 10-20% larger target utilization 324, current utilization 322 is 20-30% larger target utilization 324, etc.). In some cases, an output of comparator circuit 312 may indicate a number of credits. The number of credits may indicate a specified amount of hardware resources allocated to the process per a specified number of execution cycles, as compared to an expected amount of hardware resources allocated to the process per the specified number of execution cycles.

Process priority adjustment circuit 314 may determine whether to adjust, via priority signal(s) 212a-m, a priority of one or more processes at one or more clusters (e.g., one or more of clusters 204a-m) based on the result from comparator circuit 312. In some cases, at least some of the one or more clusters where the priority is adjusted may be different from the cluster corresponding to current utilization 322. As noted above, the result may indicate that a difference between current utilization 322 and target utilization 324 is within a specified range. In response to the difference being within the specified range, process priority adjustment circuit 314 may determine not to adjust the priority of the process at one or more clusters. In some embodiments, priority signal 212a may be sent to process priority list 316, indicating no adjustment to the priority should be made. In other embodiments, priority signal 212a may not be sent. In response to the result being outside the specified range and current utilization 322 being larger than target utilization 324, process priority adjustment circuit 314 may reduce the priority of the process at one or more clusters (e.g., via priority signal 212a). In response to the result being outside the specified range and current utilization 322 being smaller than target utilization 324, process priority adjustment circuit 314 may increase the priority of the process at one or more clusters (e.g., via priority signal 212a). The priority may be adjusted by a fixed amount or may be based on the difference between current utilization 322 and target utilization 324. In some cases, process priority adjustment circuit 314 may track a total difference for the process based on a plurality of outputs from comparator circuit 312 (e.g., multiple outputs corresponding to a single cluster, outputs corresponding to multiple clusters, or both).

As noted above, in some embodiments, the results from comparator circuit 312 may indicate a number of credits. Process priority adjustment circuit 314 may track a total number of credits for the process. Additionally, process priority adjustment circuit 314 may adjust the priority of the process based on the total number of credits exceeding or falling below various specified thresholds. The adjusted priority may be used by hardware resource arbitration circuit 304 in future allocation cycles to reallocate hardware resources 302. As discussed above, in some embodiments, the priority may be adjusted such that allocation of hardware resources 302 to processes at cluster 204a trends towards a specified ratio over a period of time (e.g., 1 millisecond or 1 second), as opposed to the allocation being the specified ratio.

In some embodiments, process priority adjustment circuit 314 may use additional information to adjust the priority. For example, process priority adjustment circuit 314 may receive results from comparator circuits corresponding to other processes (e.g., received at cluster 204a from other process queues than the process corresponding to director circuit 206a). As another example, process priority adjustment circuit 314 may save information from previous results received from comparator circuit 312. As a third example, process priority adjustment circuit 314 may receive an indication of a number of hardware resources requested by the process at one or more of clusters 204.

As noted above, in some cases, various processes may have specified ranges of priorities. The specified ranges may be based on the processes themselves (e.g., based on a process type), based on a priority requested by the process, based on a process queue from which the process was received, or based on other factors. The specified ranges may differ at different clusters. In some embodiments, process priority adjustment circuit 314 may adjust priorities based on the specified ranges such that the adjusted priorities are in the specified ranges.

In some cases, process priority adjustment circuit 314 may identify the process as being ill-behaved or hung. For example, in response to determining that current utilization 322 exceeds target utilization 324, determining that the priority of the process is already a lowest priority that can be assigned, and determining that one or more other processes are receiving an insufficient number of resources, process priority adjustment circuit 314 may identify the process as being ill-behaved. As another example, in response to determining that the process is failing to utilize an allocated portion of hardware resources 302 despite being allocated a requested portion of hardware resources 302 for a particular amount of time, process priority adjustment circuit 314 may identify the process as being hung. The process may be identified as ill-behaved or hung based on a difference between current utilization 322 and target utilization 324 exceeding one or more specified amounts. In various embodiments where credits are used, the process may be identified as being ill-behaved or hung in response to the number of credits exceeding or falling below respective specified thresholds. In some embodiments, in response to identifying the process as being ill-behaved or hung, process priority adjustment circuit 314 may indicate to one or more of clusters 204a-m that a context switch should occur for the process or that the process should be terminated. The indication may be sent via one or more of priority signal 212a-m (e.g., setting the priority to a particular value) or may be sent to one or more other devices (e.g., to hardware resource arbitration circuit 304 directly).

Referring now to FIG. 4, a flow diagram of a method 400 of allocating hardware resources of a processing circuit is depicted. In some embodiments, method 400 may be initiated or performed by one or more processors in response to one or more instructions stored by a computer-readable storage medium.

At 402, method 400 includes receiving current utilizations of a plurality of hardware resources by a respective plurality of processes. For example, method 400 may include director circuits 206a-n of FIG. 2 receiving current utilizations of hardware resources (e.g., hardware resources 302 of FIG. 3) at clusters 204a-m.

At 404, method 400 includes determining respective utilizations of the plurality of hardware resources by the plurality of processes over a particular amount of time. For example, method 400 may include director circuits 206a-n determining, at respective utilization accumulation circuits (e.g., utilization accumulation circuit 308) respective utilizations of the plurality of hardware resources by respective processes over a particular amount of time.

At 406, method 400 includes determining target utilizations of the plurality of hardware resources by the plurality of processes. For example, method 400 may include director circuits 206a-n determining, at respective target utilization circuits (e.g., target utilization circuit 310) respective utilizations of the plurality of hardware resources by respective processes over a particular amount of time.

At 408, method 400 includes adjusting, for a particular process of the plurality of processes, a priority based on the current utilization of the particular process and the target utilization of the particular process. For example, method 400 may include process priority adjustment circuit 314 adjusting, via priority signal 212a, a priority of a process at process priority list 316 based on current utilization 322 and target utilization 324. The adjusted priorities may be used to reallocate the hardware resources. Accordingly, a method of allocating hardware resources of a processing circuit is depicted.

Turning next to FIG. 5, a block diagram illustrating an exemplary embodiment of a computing system 500 that includes at least a portion of a processing circuit hardware resource allocation system. The computing system 500 includes graphics unit 150 of FIG. 1. In some embodiments, graphics unit 150 includes one or more of the circuits described above with reference to FIG. 1, including any variations or modifications described previously with reference to FIGS. 1-4. For example, in the illustrated embodiment, graphics unit 150 includes cluster(s) 204 and director circuit(s) 206 of FIGS. 2 and 3. In some embodiments, some or all elements of the computing system 500 may be included within a system on a chip (SoC). In some embodiments, computing system 500 is included in a mobile device. Accordingly, in at least some embodiments, area and power consumption of the computing system 500 may be important design considerations. In the illustrated embodiment, the computing system 500 includes fabric 510, graphics unit 150, compute complex 520, input/output (I/O) bridge 550, cache/memory controller 545, and display unit 565. Although the computing system 500 illustrates graphics unit 150 as being connected to fabric 510 as a separate device of computing system 500, in other embodiments, graphics unit 150 may be connected to or included in other components of the computing system 500. Additionally, the computing system 500 may include multiple graphics units 150. The multiple graphics units 150 may correspond to different embodiments or to the same embodiment. Further, although in the illustrated embodiment, cluster(s) 204 and director circuit(s) 206 are part of graphics unit 150, in other embodiments, cluster(s) 204, director circuit(s) 206, or both may be a separate device or may be included in other components of computing system 500.

Fabric 510 may include various interconnects, buses, MUXes, controllers, etc., and may be configured to facilitate communication between various elements of computing system 500. In some embodiments, portions of fabric 510 are configured to implement various different communication protocols. In other embodiments, fabric 510 implements a single communication protocol and elements coupled to fabric 510 may convert from the single communication protocol to other communication protocols internally.

In the illustrated embodiment, compute complex 520 includes bus interface unit (BIU) 525, cache 530, and cores 535 and 540. In some embodiments, cores 535 and 540 may correspond to execution units of clusters 204a-m. In various embodiments, compute complex 520 includes various numbers of cores and/or caches. For example, compute complex 520 may include 1, 2, or 4 processor cores, or any other suitable number. In some embodiments, cores 535 and/or 540 include internal instruction and/or data caches. In some embodiments, a coherency unit (not shown) in fabric 510, cache 530, or elsewhere in computing system 500 is configured to maintain coherency between various caches of computing system 500. BIU 525 may be configured to manage communication between compute complex 520 and other elements of computing system 500. Processor cores such as cores 535 and 540 may be configured to execute instructions of a particular instruction set architecture (ISA), which may include operating system instructions and user application instructions.

Cache/memory controller 545 may be configured to manage transfer of data between fabric 510 and one or more caches and/or memories (e.g., non-transitory computer readable mediums). For example, cache/memory controller 545 may be coupled to an L3 cache, which may, in turn, be coupled to a system memory. In other embodiments, cache/memory controller 545 is directly coupled to a memory. In some embodiments, the cache/memory controller 545 includes one or more internal caches. In some embodiments, the cache/memory controller 545 may include or be coupled to one or more caches and/or memories that include instructions that, when executed by one or more processors (e.g., compute complex 520 and/or graphics unit 150), cause the processor, processors, or cores to initiate or perform some or all of the processes described above with reference to FIGS. 1-4 or below with reference to FIG. 6.

As used herein, the term “coupled to” may indicate one or more connections between elements, and a coupling may include intervening elements. For example, in FIG. 5, display unit 565 may be described as “coupled to” compute complex 520 through fabric 510. In contrast, in the illustrated embodiment of FIG. 5, display unit 565 is “directly coupled” to fabric 510 because there are no intervening elements.

Graphics unit 150 may include one or more processors and/or one or more graphics processing units (GPU's). Graphics unit 150 may receive graphics-oriented instructions, such as OPENGL®, Metal, or DIRECT3D® instructions, for example. Graphics unit 150 may execute specialized GPU instructions or perform other operations based on the received graphics-oriented instructions. Graphics unit 150 may generally be configured to process large blocks of data in parallel and may build images in a frame buffer for output to a display. Graphics unit 150 may include transform, lighting, triangle, and/or rendering engines in one or more graphics processing pipelines, which may correspond to process queues 202a-k. Graphics unit 150 may output pixel information for display images. In the illustrated embodiment, graphics unit 150 includes programmable shader 160.

Display unit 565 may be configured to read data from a frame buffer and provide a stream of pixel values for display. Display unit 565 may be configured as a display pipeline in some embodiments. Additionally, display unit 565 may be configured to blend multiple frames to produce an output frame. Further, display unit 565 may include one or more interfaces (e.g., MIPI® or embedded display port (eDP)) for coupling to a user display (e.g., a touchscreen or an external display).

I/O bridge 550 may include various elements configured to implement: universal serial bus (USB) communications, security, audio, and/or low-power always-on functionality, for example. I/O bridge 550 may also include interfaces such as pulse-width modulation (PWM), general-purpose input/output (GPIO), serial peripheral interface (SPI), and/or inter-integrated circuit (I2C), for example. Various types of peripherals and devices may be coupled to computing system 500 via I/O bridge 550. In some embodiments, graphics unit 150 may be coupled to computing system 500 via I/O bridge 550.

FIG. 6 is a block diagram illustrating a process of fabricating at least a portion of a processing circuit hardware resource allocation system. FIG. 6 includes a non-transitory computer-readable medium 610 and a semiconductor fabrication system 620. Non-transitory computer-readable medium 610 includes design information 615. FIG. 6 also illustrates a resulting fabricated integrated circuit 630. In the illustrated embodiment, integrated circuit 630 includes cluster(s) 204 and director circuit(s) 206 of FIGS. 2 and 3. However, in other embodiments, integrated circuit 630 may only include one of cluster(s) 204 or director circuit(s) 206. In some embodiments, integrated circuit 630 may include a subset of cluster(s) 204, director circuit(s) 206, or both. In the illustrated embodiment, semiconductor fabrication system 620 is configured to process design information 615 stored on non-transitory computer-readable medium 610 and fabricate integrated circuit 630.

Non-transitory computer-readable medium 610 may include any of various appropriate types of memory devices or storage devices. For example, non-transitory computer-readable medium 610 may include at least one of an installation medium (e.g., a CD-ROM, floppy disks, or tape device), a computer system memory or random access memory (e.g., DRAM, DDR RAM, SRAM, EDO RAM, Rambus RAM, etc.), a non-volatile memory such as a Flash, magnetic media (e.g., a hard drive, or optical storage), registers, or other types of non-transitory memory. Non-transitory computer-readable medium 610 may include two or more memory mediums, which may reside in different locations (e.g., in different computer systems that are connected over a network).

Design information 615 may be specified using any of various appropriate computer languages, including hardware description languages such as, without limitation: VHDL, Verilog, SystemC, SystemVerilog, RHDL, M, MyHDL, etc. Design information 615 may be usable by semiconductor fabrication system 620 to fabricate at least a portion of integrated circuit 630. The format of design information 615 may be recognized by at least one semiconductor fabrication system 620. In some embodiments, design information 615 may also include one or more cell libraries, which specify the synthesis and/or layout of integrated circuit 630. In some embodiments, the design information is specified in whole or in part in the form of a netlist that specifies cell library elements and their connectivity. Design information 615, taken alone, may or may not include sufficient information for fabrication of a corresponding integrated circuit (e.g., integrated circuit 630). For example, design information 615 may specify circuit elements to be fabricated but not their physical layout. In this case, design information 615 may be combined with layout information to fabricate the specified integrated circuit.

Semiconductor fabrication system 620 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 620 may also be configured to perform various testing of fabricated circuits for correct operation.

In various embodiments, integrated circuit 630 is configured to operate according to a circuit design specified by design information 615, which may include performing any of the functionality described herein. For example, integrated circuit 630 may include any of various elements described with reference to FIGS. 1-5. Further, integrated circuit 630 may be configured to perform various functions described herein in conjunction with other components. The functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components.

In some embodiments, a method of initiating fabrication of integrated circuit 630 is performed. Design information 615 may be generated using one or more computer systems and stored in non-transitory computer-readable medium 610. The method may conclude when design information 615 is sent to semiconductor fabrication system 620 or prior to design information 615 being sent to semiconductor fabrication system 620. Accordingly, in some embodiments, the method may not include actions performed by semiconductor fabrication system 620. Design information 615 may be sent to fabrication system 620 in a variety of ways. For example, design information 615 may be transmitted (e.g., via a transmission medium such as the Internet) from non-transitory computer-readable medium 610 to semiconductor fabrication system 620 (e.g., directly or indirectly). As another example, non-transitory computer-readable medium 610 may be sent to semiconductor fabrication system 620. In response to the method of initiating fabrication, semiconductor fabrication system 620 may fabricate integrated circuit 630 as discussed above.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A system, comprising:
a utilization accumulation circuit configured to determine a utilization of a plurality of hardware resources by a process over a particular amount of time;
a comparator circuit configured to compare a current utilization of the plurality of hardware resources with a target utilization of the plurality of hardware resources, wherein the target utilization is determined based on the utilization of the plurality of hardware resources by the process over the particular amount of time; and
a process priority adjustment circuit configured, based on an output of the comparator circuit, to adjust a priority of the process.

2. The system of claim 1, further comprising a hardware resource utilization sensor configured to detect the current utilization of a plurality of hardware resources by the process.

3. The system of claim 1, further comprising a hardware resource arbitration circuit configured to allocate the plurality of hardware resources to the process based on the priority of the process.

4. The system of claim 1, wherein the comparator circuit is configured to indicate a difference between the current utilization and the target utilization.

5. The system of claim 4, wherein the process priority adjustment circuit is configured to track a total difference for the process based on a plurality of outputs of the comparator circuit.

6. The system of claim 5, wherein the process priority adjustment circuit is configured to:
adjust the priority of the process by a first amount in response to the total difference having a value between a first value and a second value; and
adjust the priority of the process by a second amount in response to the total difference having a value greater than the second value.

7. The system of claim 5, wherein the process priority adjustment circuit is configured to initiate a context switch of the process in response to the total difference exceeding a particular amount.

8. The system of claim 1, wherein the target utilization is determined based on a utilization of the plurality of hardware resources by a second process over the particular amount of time.

9. The system of claim 8 wherein data of the process is received from first process queue, and wherein data of the second process is received from a second process queue.

10. The system of claim 9, wherein the process priority adjustment circuit is configured to adjust priorities such that processes received from the first process queue are within a first range of priorities and processes received from the second process queue are within a second range of priorities.

11. A method, comprising,
receiving current utilizations of a plurality of hardware resources by a respective plurality of processes;
determining respective utilizations of the plurality of hardware resources by the plurality of processes over a particular amount of time;
determining target utilizations of the plurality of hardware resources by the plurality of processes;
adjusting, for a particular process of the plurality of processes, a priority based on the current utilization of the particular process and the target utilization of the particular process.

12. The method of claim 11, further comprising adjusting the current utilizations of the plurality of hardware resources by the plurality of processes based on adjusting the priority of the particular process.

13. The method of claim 11, wherein adjusting the priority of the particular process causes a resource utilization of the plurality of hardware resources by the particular process to be within a specified range over a specified amount of time.

14. The method of claim 11, wherein target utilizations are determined based on an amount of the plurality of hardware resources requested by the plurality of processes.

15. The method of claim 11, wherein adjusting the priority of the particular process comprises determining that the adjusted priority is within a specified range of priorities.

16. The method of claim 11, wherein the priority of the process is determined based on a process type, a priority requested by the process, and a queue from which the process is received.

17. The method of claim 11, further comprising:
performing, for a second process of the plurality of processes, a second comparison between the current utilization of the second process and the target utilization of the second process; and
in response to a difference between the current utilization of the second process and the target utilization of the second process exceeding a specified threshold, terminating the second process.

18. A non-transitory computer readable storage medium having stored thereon design information that specifies a circuit design in a format recognized by a fabrication system that is configured to use the design information to fabricate a hardware integrated circuit that includes circuitry configured to operate according to the circuit design, wherein the circuitry includes:
a hardware resource utilization sensor configured to detect a current utilization of a plurality of hardware resources by a process;
a utilization accumulation circuit configured to determine a utilization of the plurality of hardware resources by the process over a particular amount of time;
a comparator circuit configured to compare the current utilization of the plurality of hardware resources with a target utilization of the plurality of hardware resources, wherein the target utilization is determined based on the utilization of the plurality of hardware resources by the process over the particular amount of time; and
a process priority adjustment circuit configured, based on an output of the comparator circuit, to adjust a priority of the process.

19. The non-transitory computer readable storage medium of claim 18, wherein the circuitry further includes a hardware resource arbitration circuit configured to allocate the plurality of hardware resources to the process based on the priority of the process.

20. The non-transitory computer readable storage medium of claim 18, wherein the plurality of hardware resources comprise an execution unit and a plurality of registers.
